(19) United States
(12) Patent Application Publication
(10) Pub. No.: US 2021/0404251 A1
(43) Pub. Date: Dec. 30, 2021

(54) OPENING COVERING FOR BUILDING OPENING AND HEADRAIL THEREOF

(71) Applicant: Nien Made Enterprise Co., Ltd., Taichung (TW)

(72) Inventors: Chao-Hung Nien, Taichung (TW); Wen-Yeu Lee, Tainan City (TW); Ching-Fang Yeh, Taichung (TW); Lin Chen, Taichung (TW)

(21) Appl. No.: 16/914,500

(22) Filed: Jun. 29, 2020

(51) Int. Cl. E06B 9/78; E06B 9/36

(52) U.S. Cl. CPC E06B 9/78; E06B 2009/2488; E06B 9/362

(57) ABSTRACT

A headrail, which is included in an opening covering for a building opening, includes a frame and a fixing member. The frame, by definition, has a longitudinal axis, and the frame forms a first sub-frame and a second sub-frame in a direction along the longitudinal axis. The fixing member is optionally provided at the frame. When the fixing member is provided at the frame and bridge the first sub-frame and the second sub-frame at the same time, the first sub-frame and the second sub-frame are fixedly connected to each other in an aligned manner.

### BACKGROUND OF THE INVENTION

### 1. Field of the Invention

The present invention relates generally to an opening covering used for building openings, and more particularly to a headrail structure which can be disassembled and assembled by sections, and to an opening covering having said headrail structure.

### 2. Description of the Prior Art

An opening covering which is commonly used for building openings at least includes a headrail and a covering material in its structure. The covering material is typically made of soft or flexible materials, and therefore can be rolled or folded for transport to meet different packaging requirements; the volumes for shipments can be effectively reduced as a result. However, since a headrail has to bear the weight of the covering material and other components, it would have no other choices but to use rigid material for its making in order to provide sufficient strength. Unlike the covering material mentioned above, a headrail made of rigid materials cannot be rolled or folded for storage. In other words, a rigid headrail cannot be adjusted according to different packaging requirements. In particular, packaging or shipping a large size opening covering would be highly inconvenient, for the headrail would be quite long. Therefore, there is still room for improvement.

### SUMMARY OF THE INVENTION

One aspect of the present invention is to provide a headrail of an opening covering for a building opening, and to provide an opening covering, wherein the structure of the headrail allows it to be disassembled or assembled by sections, and therefore the headrail could be adjusted to meet different packaging requirements, which would effectively reduce the shipment volumes.

The present invention provides a headrail of an opening covering for a building opening, wherein the headrail includes a frame and a fixing member. The frame is defined to have a longitudinal axis. A first sub-frame and a second sub-frame are formed in a direction along the longitudinal axis. The fixing member is optionally provided at the frame. When the fixing member is provided at the frame, and bridges the first sub-frame and the second sub-frame at the same time, the first sub-frame and the second sub-frame are aligned with and connected to each other.

In an embodiment, the fixing member includes a first fixing portion and a second fixing portion. When the fixing member bridges the first sub-frame and the second sub-frame to make the first sub-frame and the second sub-frame connected to each other in an aligned manner, the first fixing portion is fixedly provided at the first sub-frame, and the second fixing portion is fixedly provided at the second sub-frame.

In an embodiment, the first sub-frame includes a first top board, and the second sub-frame includes a second top board. The first fixing portion is provided at the first top board, and the second fixing portion is provided at the second top board.

In an embodiment, the headrail further includes a connecting member, which is optionally provided at an inner wall of the frame to bridge the first sub-frame and the second sub-frame.

In an embodiment, the frame has a hook portion formed on a top surface thereof, and the fixing member has a restriction portion on a bottom surface thereof. When the fixing member bridges the first sub-frame and the second sub-frame to make the first sub-frame and the second sub-frame aligned with and connected to each other, the restriction portion fits into the hook portion.

In an embodiment, the first fixing portion has a recess, and the second fixing portion has a projecting block, which is adapted to be correspondingly fitted into the recess.

In an embodiment, the projecting block is adapted to be correspondingly fitted into the recess in a detachable manner.

In an embodiment, the headrail further includes a sliding track assembly provided inside the frame, wherein the sliding track assembly includes a sliding track and a linking rod. The sliding track includes a first track section and a second track section, wherein the first track section and the second track section are adjacently provided in the direction along the longitudinal axis. The linking rod is provided at the sliding track and connecting the first track section and the second track section so that the first track section and the second track section are aligned with and fixed to each other.

In an embodiment, the first track section has a channel formed on an end surface thereof facing the second track section, and the second track section also has a channel formed on an end surface thereof facing the first track section. The linking rod is adapted to be inserted into the channels.

In an embodiment, shapes of cross-sections of the channels of the first track section and the second track section correspond to a shape of a cross-section of the linking rod, and said shapes are all non-circular.

In an embodiment, each of the first track section and the second track section has a main body, and further has a channel and an extension section formed at where the first track section and the second track section are adjacent to each other. The linking rod includes an insertion section and two rod portions, wherein the rod portions respectively extend from two ends of the insertion section, and are respectively provided in a manner corresponding to the channel of the first track section and the channel of the second track section. A shape of a cross-section of the insertion section corresponds to a shape of a cross-section of each of the extension sections. When the first track section, the second track section, and the linking rod are assembled, each of the rod portions of the linking rod is respectively inserted into one of the channels, and a shape of a cross-section of a junction between the insertion section and each of the extension sections is substantially the same with a shape of a cross-section of the main body of the first track section or the main body of the second track section.

In an embodiment, the headrail further includes a track supporting member, which is detachably provided at the frame. The track supporting member includes a supporting portion. When the track supporting member is attached to the frame, an end of the supporting portion supports the sliding track assembly.

In an embodiment, the track supporting member includes a holding portion. The supporting portion is connected to the holding portion, and the track supporting member is detachably provided at the frame through the holding portion.

In an embodiment, the frame defines a receiving space and an opening communicating with the receiving space. The frame includes a bottom board, and the bottom board is provided with the opening. The holding portion of the track supporting member is adapted to be snap-fitted to the bottom board.

The present invention also provides an opening covering used for a building opening, wherein the opening covering includes the aforementioned headrail. Through the cooperation between the frame and the fixing member, the first sub-frame and the second sub-frame of the frame could be disassembled or assembled as required, whereby to enhance the convenience of packaging and shipment.

The headrail included in an opening covering used for a building opening and the opening covering itself, which are both provided in the present invention, will be further described in the following paragraphs. However, a person skilled in the art should be able to understand that the detailed descriptions and the specific embodiments exemplified for carrying out the present invention are provided for illustrative purposes only, and are not limitations for the scope claimed in the present invention.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view of some embodiments of the present invention.

FIG. 2 is a front view of the embodiments shown in FIG. 1.

FIG. 3 is an exploded view showing some parts of the embodiments shown in FIG. 1.

FIG. 4A is an enlarged exploded view of some parts of the embodiments shown in FIG. 1, mainly revealing the structures of the frame, fixing member, and connecting member.

FIG. 4B is a sectional view along the 4B-4B line in FIG. 4A, showing the frame of the embodiments.

FIG. 4C is a sectional view along the 4C-4C line in FIG. 4A, showing the frame of the embodiments in another direction.

FIG. 5 is a sectional view along the 5-5 line in FIG. 1.

FIG. 6 is an enlarged exploded view of the sliding track assembly of the embodiments shown in FIG. 1, wherein the first track section is shown in transparent to reveal the structure of the first channel thereof.

FIG. 7 is a sectional view of the embodiments shown in FIG. 6, mainly showing the connection between the sliding track and the linking rod after the sliding track assembly is assembled.

FIG. 8 is a perspective view of other embodiments of the present invention.

FIG. 9 is a partially enlarged view of the embodiments shown in FIG. 8.

FIG. 10 is an exploded view of the embodiments shown in FIG. 8.

FIG. 11 is a perspective view of the fixing member of the embodiments shown in FIG. 8, wherein the first fixing portion is shown in transparent to reveal the recess thereof.

FIG. 12 is a partially enlarged view of the sliding track assembly of the embodiments shown in FIG. 8.

FIG. 13 is an exploded view of the sliding track assembly of the embodiments shown in FIG. 8.

FIG. 14 is a sectional view along the 14-14 line in FIG. 13.

FIG. 15 is a sectional view along the 15-15 line in FIG. 12.

FIG. 16 is a sectional view along the 16-16 line in FIG. 12.

FIG. 17 is a view seen along the 17-17 line in FIG. 8, showing the left view of the second sub-frame of the embodiments.

FIG. 18 is a perspective view of the track supporting member of the embodiments shown in FIG. 8.

### DETAILED DESCRIPTION

The following paragraph, along with the drawings, will explain the features, implementations, and similar key points of the headrail of the opening covering, which is used for building openings, and the opening covering itself. In the drawings, one or more implementations of the headrail and the opening covering are showed and illustrated. Understandably, the features, implementations, and similar key points mentioned in the following paragraphs can be used solely or jointly. In addition, the headrail and the opening covering disclosed in the present invention can be carried out in various forms, and should not be deemed limited to the embodiments described in the present invention which render all features. In the drawings, unless specified, the same reference characters always refer to the same components.

In addition, it has to be specified that, the technical features provided by the present invention are not limited to the specific structures, uses, and applications described in the embodiments. The words used in the descriptions are exemplified descriptive words that a person skilled in the art could understand. The words in the specification describing directions, such as “front”, “rear”, “up”, “down”, “left”, “right”, “top”, “bottom”, “in”, and “out”, are also merely exemplified descriptive words based on the directions in normal use, and have no intent to limit the claim scope of the present invention.

Furthermore, as in claims, the singular form of quantifiers such as “a”, “one”, and “the” all include the meaning of plurality. Therefore, descriptions regarding, say, “a component” may refer to one or more components, and further include equivalent alternatives known by a person having ordinary skills in the art. All conjunctions used in similar situations should be interpreted in a widest reasonable manner as well. Specific shapes, structural features, or technical terms described in the specification should also be interpreted to include equivalent alternative structures or technical terms that can perform the same function as said specific structure or technical terms.

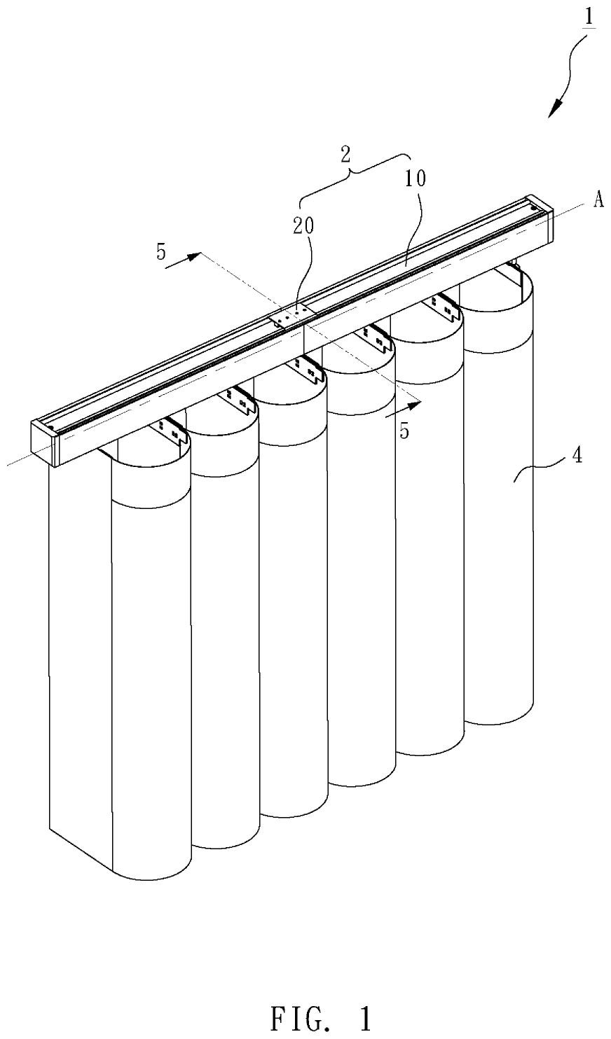

An opening covering 1 based on some embodiments of the present invention for a building opening is shown in FIG. 1 to FIG. 3. Said building opening could include, but not limited to, a window, a door, an arch, and the like. The opening covering 1 includes a headrail 2, a covering material 4, and a control mechanism 6 adapted to control the covering material 4. Said control mechanism 6 includes an adjusting rod 7 and a movable seat assembly 8, wherein the movable seat assembly 8 is operably connected to the adjusting rod 7, and the covering material 4 is operably suspended from the movable seat assembly 8. By maneuvering the adjusting rod 7, the movable seat assembly 8 is adapted to be driven to move, whereby to correspondingly expand, collect, or tilt the covering material 4. However, the arrangements and operations of the above-mentioned covering material 4 and control mechanism 6 are not what to be claimed in the present invention, and therefore we are not going to further describe related details. Nevertheless, it has to be clarified that, although the opening covering 1 and its headrail 2 in the exemplified embodiment disclosed in the present invention take a vertical blind as an example, this should not be interpreted as a limitation; in other feasible embodiments, the opening covering can also be a horizontal blind or any kinds of window blinds which have a headrail.

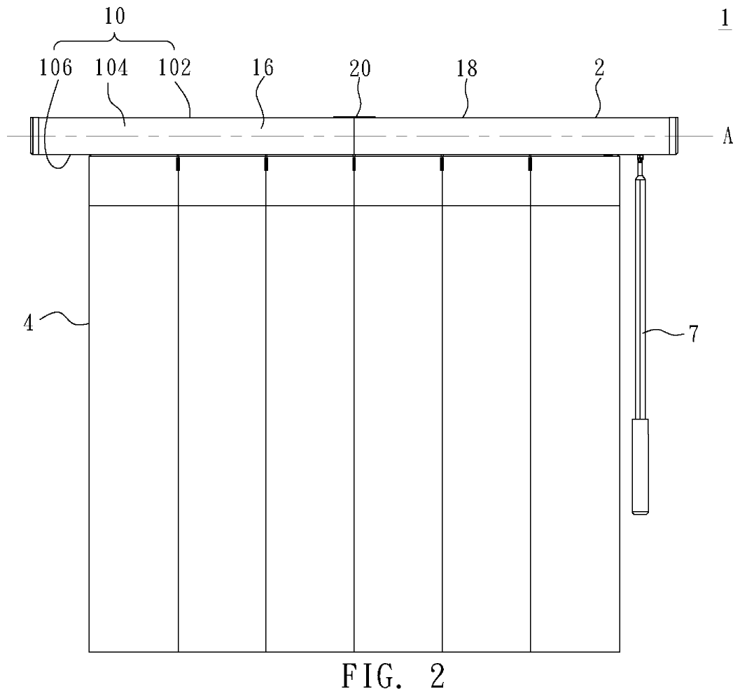

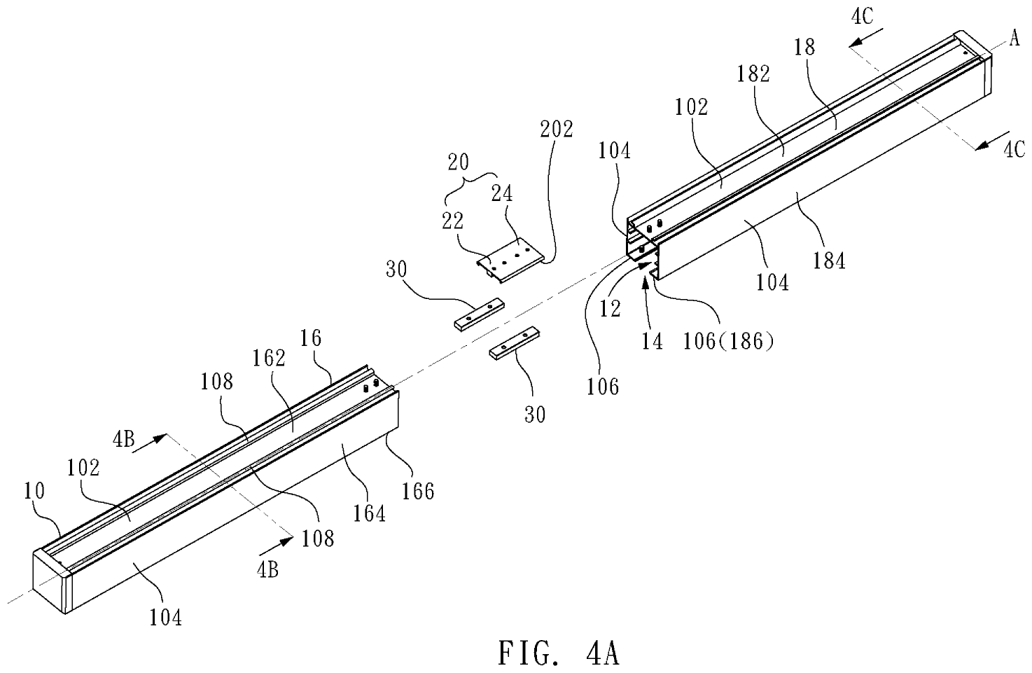

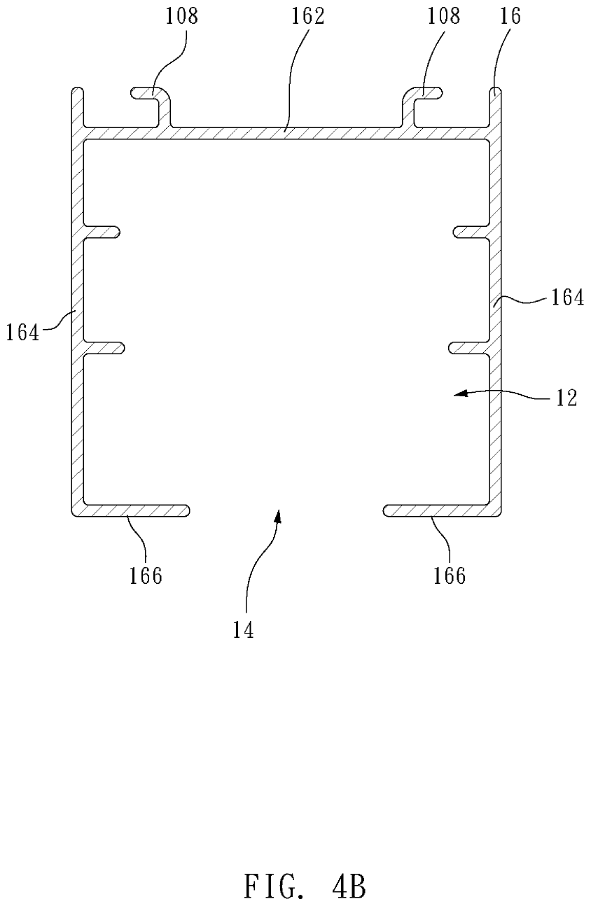

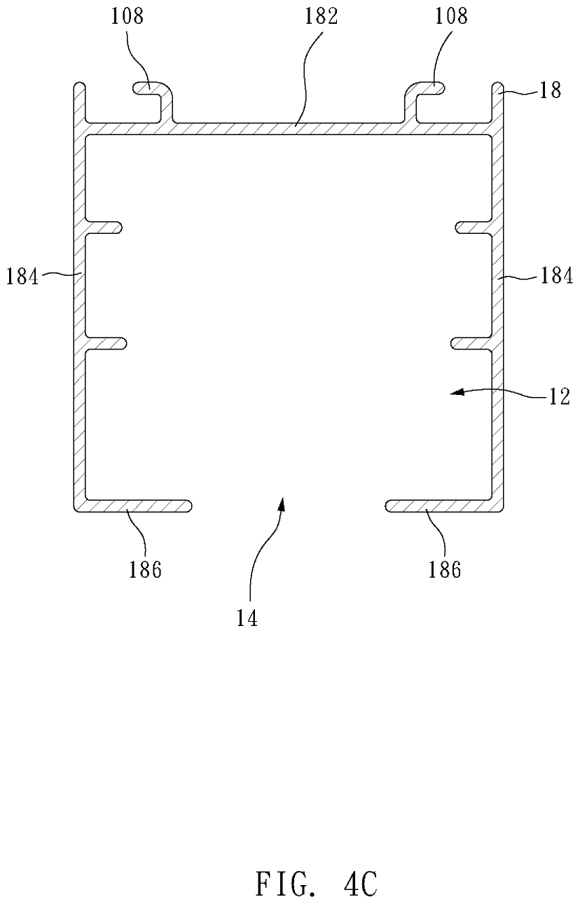

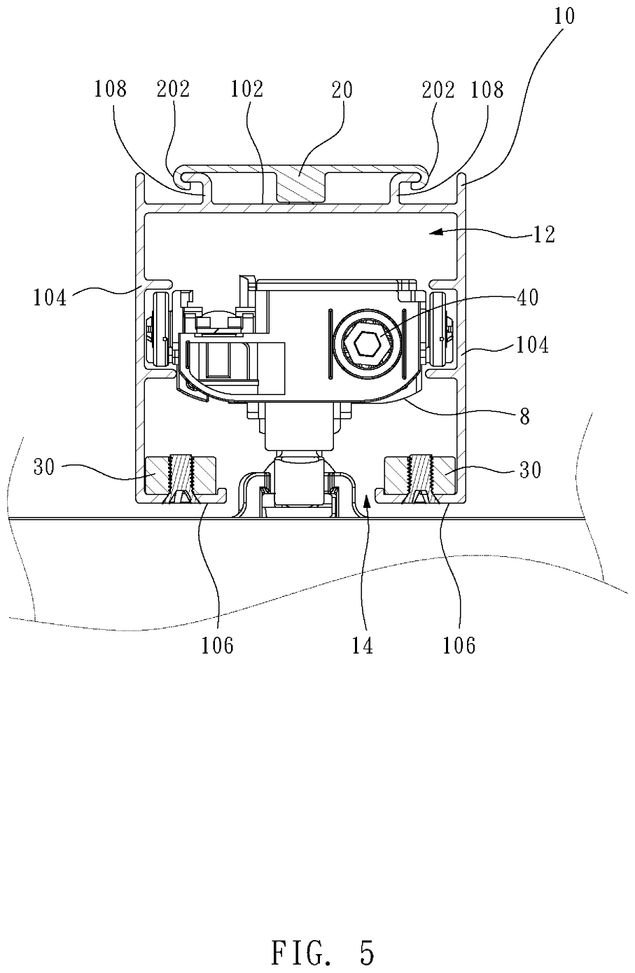

As shown in FIG. 2 to FIG. 5, in some embodiments, the headrail 2 includes a frame 10 and a fixing member 20, wherein the frame 10 can be, but not limited to, made of rigid materials, such as metal, alloy, or composite materials. Furthermore, the frame 10 can be, but not limited to, a roughly hollow cuboid, which defines a receiving space 12 and an opening 14 communicating the receiving space 12, wherein the receiving space 12 accommodates the movable seat assembly 8 therein. In addition, the frame 10 is defined to have a longitudinal axis A passing through left and right sides of the frame 10. In the direction along the longitudinal axis A, the frame 10 is assembled by connecting a first sub-frame 16 and a second sub-frame 18 in an aligned manner.

Similarly, the fixing member 20 mentioned above can be, but not limited to, made of rigid material such as metal, alloy, or composite materials. Said fixing member 20 is provided at the frame 10. By using the fixing member 20 to bridge the first sub-frame 16 and the second sub-frame 18 which are aligned, the aligned first sub-frame 16 and second sub-frame 18 can be engaged in a manner that they abut against each other.

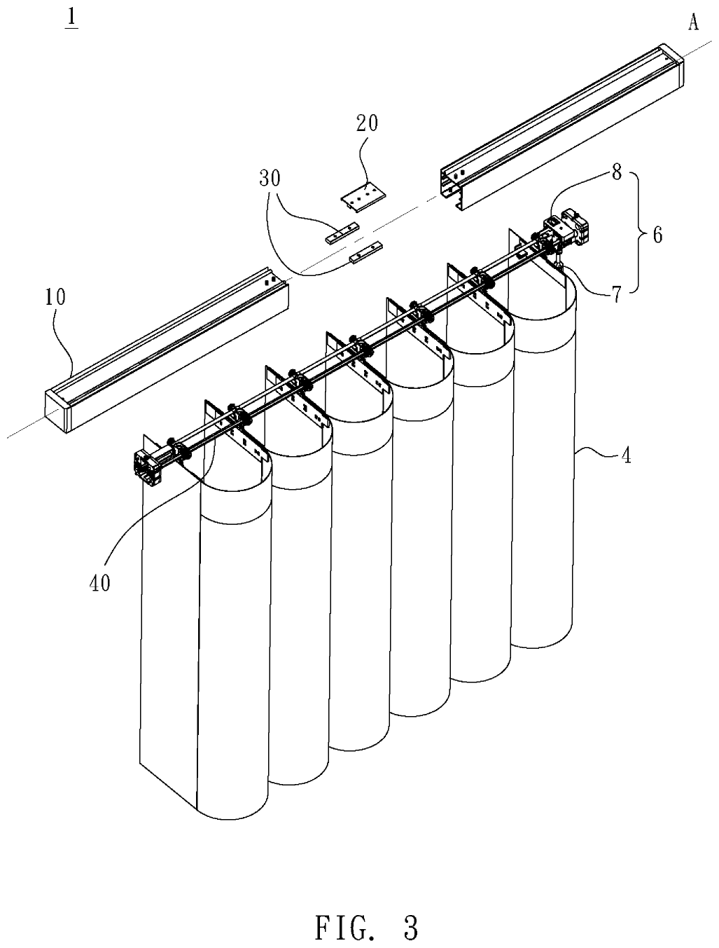

As shown in FIG. 1, and FIG. 3 to FIG. 5, in some embodiments, the fixing member 20 can have an integral structure, and includes a first fixing portion 22 and a second fixing portion 24, wherein said first fixing portion 22 is fixedly provided at the first sub-frame 16, and the second fixing portion 24 is fixedly provided at the second sub-frame 18. The first fixing portion 22 and the second fixing portion 24 are respectively fixed to the first sub-frame 16 and the second sub-frame 18 through screws; however, in other feasible embodiments, the fastening means could be selected from the groups of detachable or non-detachable means such as welding, bonding, riveting, and mortise-and-tenon structure, but is not limited thereto.

Understandably, the frame 10 would have a weaker strength at the connection between the first sub-frame 16 and the second sub-frame 18, and therefore, in some embodiments, the fixing member 20 can be made of materials which have a greater hardness than the materials used for making the first sub-frame 16 and the second sub-frame 18, whereby to increase the strength of the frame 10 at the connection between the first sub-frame 16 and the second sub-frame 18. In addition, it has to be emphasized that the frame 10 of the present invention is not limited to be disassembled into only two sections (i.e., the first sub-frame 16 and the second sub-frame 18); in other feasible embodiments, the frame 10 can be also disassembled into more sub-frames. In other words, the frame 10 can be assembled by more than two sub-frames. In such cases, every two adjacent sub-frames are connected and fixed by aligning a side face of one sub-frame with a side face of the other one sub-frame, and then using the fixing member to bridge the two sub-frames.

In addition, as shown in FIG. 2 to FIG. 5, the frame 10 in some embodiments includes a top board 102, two side boards 104, and a bottom board 106. The two side boards 104 are located between the top board 102 and the bottom board 106, and all these boards 102, 104, 106 surround (and therefore form) the above-mentioned receiving space 12. The above-mentioned opening 14 is provided on the bottom board 106 and communicates with the receiving space 12. If further specified, the top board 102 can be distinguished as a first top board 162 and a second top board 182, each of the side boards 104 can be distinguished as a first side board 164 and a second side board 184, and the bottom board 106 can be distinguished as a first bottom board 166 and a second bottom board 186. The above-mentioned first sub-frame 16 is composed of the first top board 162, two first side boards 164 (each of which comes from one of the side boards 104), and the first bottom board 166. Similarly, the second sub-frame 18 is composed of the second top board 182, two second side boards 184 (each of which comes from one of the side boards 104), and the second bottom board 186.

For aesthetic reasons or for the ease of assembly, in some embodiments, the first fixing portion 22 of the fixing member 20 can be provided on a top surface of the first top board 162, while the second fixing portion 24 is correspondingly provided on a top surface of the second top board 182. In other words, the whole fixing member 20 is provided at a top surface of the top board 102 of the frame 10, and bridges the top surface of the first top board 162 and the top surface of the second top board 182. With such design, the fixing member 20 can be hidden by the frame 10 from a user's regular sight, and therefore the appearance of the frame 10 could be consistent as a whole, as shown in FIG. 2. Understandably, in other feasible embodiments, the fixing member 20 can be also provided at other positions on the frame 10, such as on the side boards 104, the bottom board 106, or a bottom surface of the top board 102 (not shown).

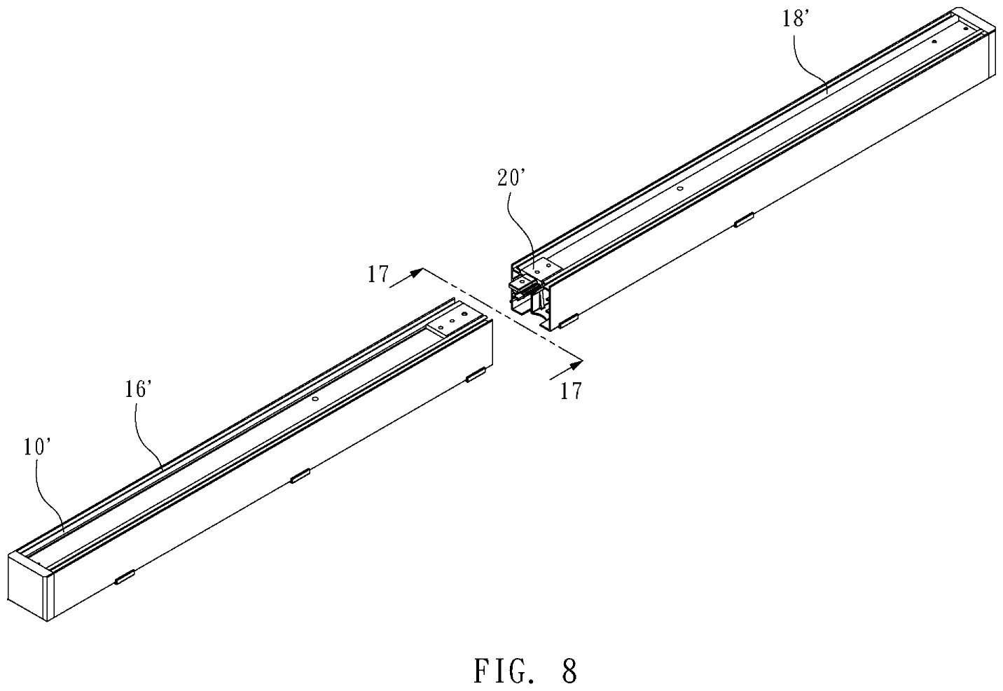

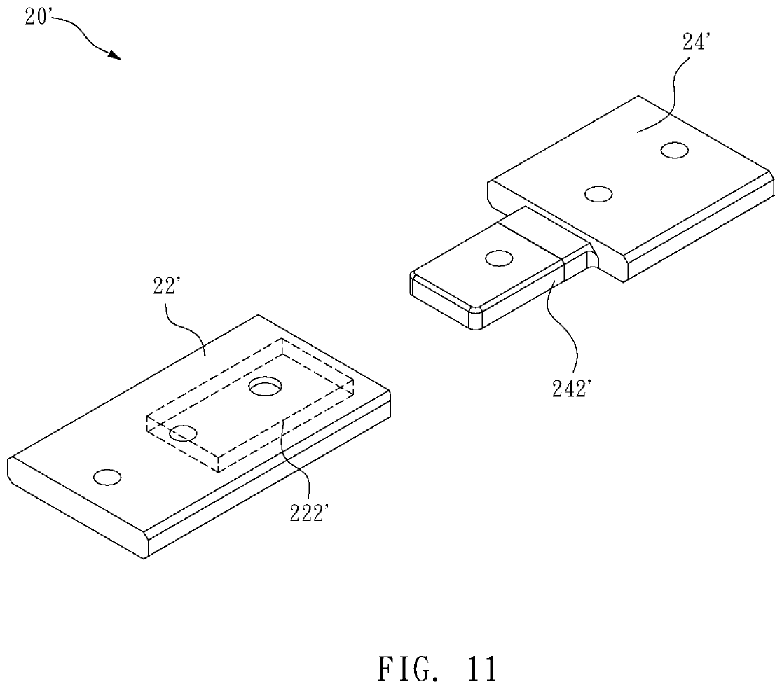

It is worth mentioning that, in addition to the above-mentioned integral design, the fixing member 20 in other feasible embodiments can have separable structures instead. As shown in FIG. 8 to FIG. 11, the fixing member 20′, which is an alternative implementation of the fixing member 20, can be assembled by two or more than two components. The first fixing portion 22′ and the second fixing portion 24′ of the fixing member 20′ are fixedly connected to each other and, preferably, are connected in a detachable manner. In this implementation, the first fixing portion 22′ has a recess 222′ (as shown in FIG. 11) formed on an end surface adjacent to the second fixing portion 24′ in a direction away from the second fixing portion 24′, and the second fixing portion 24′ has a projecting block 242′ corresponding to the recess 222′. When it is to correspondingly combine the first sub-frame 16′ and the second sub-frame 18′ to form a complete frame 10′, the only action needs to be taken is to insert the projecting block 242′ of the second fixing portion 24′ into the recess 222′ of the first fixing portion 22′. By doing so, the first sub-frame 16′ and the second sub-frame 18′ are connected to each other. If it is required to make sure the combined two not to easily separate, screws or other fastening means can be further applied to fix the connection between the recess 222′ and the projecting block 242′.

As shown in FIG. 3 to FIG. 5, in some embodiments, the top board 102 of the frame 10 can further have a pair of hook portions 108 formed on the top surface thereof. Each of the hook portions 108 extends a certain distance from the top surface of the top board 102 upwards first, and then extends toward a front side or a rear side of the frame 10, respectively. The cross-section of the hook portions 108 resembles two reversed L shapes facing opposite sides. In addition, the hook portions 108 can be, but not limited to, as long as the top board 102 in the direction of the longitudinal axis A. The fixing member 20 has a pair of restriction portions 202, of which the outlines roughly extend a certain distance downward and outward and then extend inward (i.e., toward each other). In other words, the cross-section of the restriction portions 202 roughly resembles two hooks having their openings facing each other (or two opposite C shapes with their openings facing each other). When the fixing member 20 bridges the first sub-frame 16 and the second sub-frame 18, making the first sub-frame 16 and the second sub-frame 18 aligned with and connected to each other, each of the restriction portions 202 is respectively hooked by the corresponding hook portion 108. Through the above-mentioned engagement between the hook portions 108 and the restriction portions 202, the connection strength of the first sub-frame 16 and the second sub-frame 18 provided by the fixing member 20 could be effectively enhanced.

Furthermore, as shown in FIG. 3 to FIG. 5, the headrail 2 can include, but not limited to, at least one connecting member 30 to further enhance the connection strength of the first sub-frame 16 and the second sub-frame 18 of the frame 10. Said connecting member 30 is roughly cuboid, and is provided at an inner wall of the frame 10 to bridge the first sub-frame 16 and the second sub-frame 18, i.e., said connecting member 30 is located in the receiving space 12 of the frame 10. In some embodiments, two ends of the connecting member 30 can be respectively connected to an inner wall of the first bottom board 166 and an inner wall of the second bottom board 186. However, to meet different requirements, the connecting member 30 could also bridge an inner wall of the first side board 164 and an inner wall of the second side board 184 (not shown). Of course, the connecting member 30 could bridge other locations of the frame 10 instead, such as an outer wall of the frame 10, which could provide the effect of enhancing the connection strength. In addition, the number of the connecting member 30 is not limited to what mentioned above. In practice, the number of the connecting member 30 is one, which would be sufficient to provide the effect of enhancing the connection strength. Similarly, the shape of the connecting member 30 and the means for the connecting member 30 to establish a fixed connection with the frame 10 could be varied based on specifications of products, and therefore are not limited to the exemplified implementations above.

As shown in FIG. 3 and FIG. 5 to FIG. 7, in some embodiments, the headrail 2 of the present invention further includes a sliding track assembly 40, which is provided in the receiving space 12 of the frame 10 in a direction parallel to the longitudinal axis A, and is operably connected to the adjusting rod 7. The movable seat assembly 8 is connected to the sliding track assembly 40 in a slidable manner, and can be controlled through the adjusting rod 7 to drive the covering material 4, whereby to perform operations of expanding, collecting, or tilting the covering material 4. The sliding track assembly 40 includes a sliding track 42 and a linking rod 48. Corresponding to the frame 10, the sliding track 42 has a first track section 44 and a second track section 46 formed in a direction along the longitudinal axis A. The linking rod 48 is provided at the sliding track 42, and connects the first track section 44 and the second track section 46, so that the first track section 44 and the second track section 46 are correspondingly aligned and fixedly connected. In other feasible embodiments, a length of the first track section 44 can be roughly the same as a length of the above-mentioned first sub-frame 16, and a length of the second track section 46 can be roughly the same as a length of the second sub-frame 18. However, this is not a limitation for practical applications. In addition, the number of the sub-frames that the frame 10 can be disassembled is not necessary to be the same as the number of the track sections that the sliding track 42 can be disassembled. For example, if required, the frame can be designed to have three sub-frames, while the sliding track is designed to have four track sections. In addition, the connection between the first track section 44, the second track section 46, and the linking rod 48 of the sliding track assembly 40 can be established, subject to the use requirements, in detachable or non-detachable manner; in other words, this is not a limitation of the present invention.

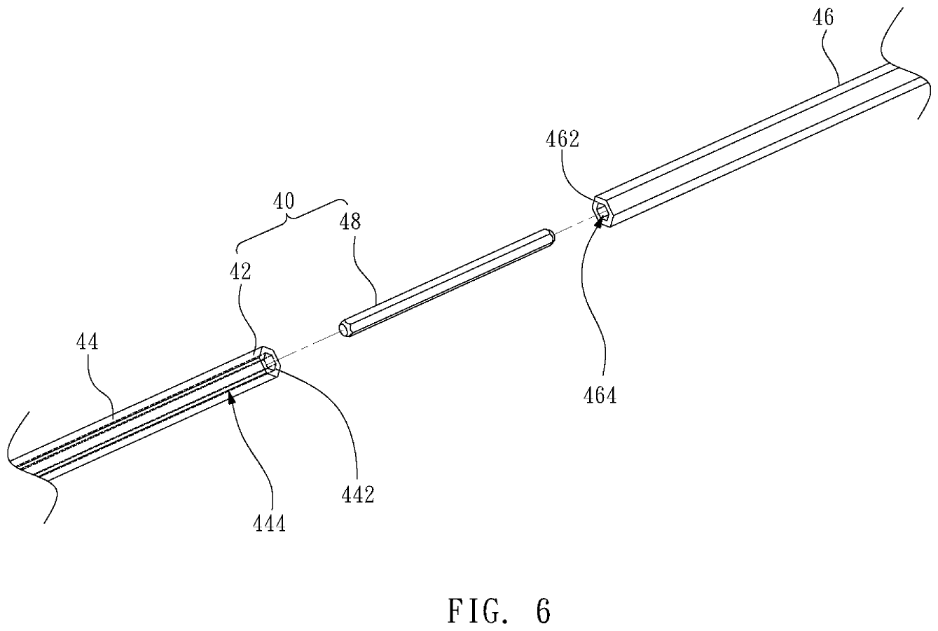

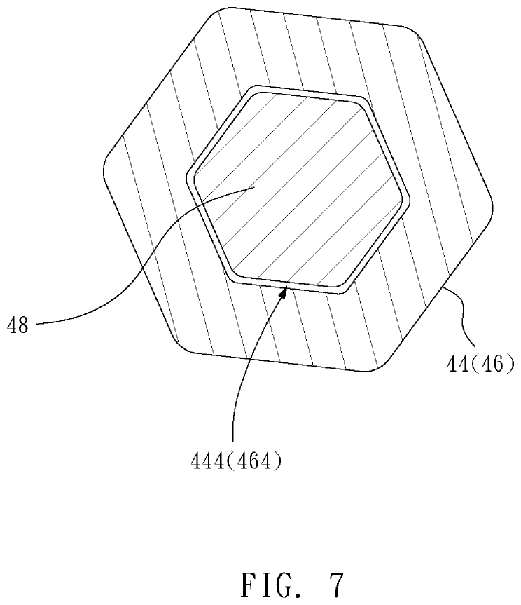

Please refer to FIG. 6 and FIG. 7, wherein FIG. 6 is a perspective exploded view showing the condition when the sliding track 42 and the linking rod 48 are not assembled, and FIG. 7 is a sectional view showing the junction between the first track section 44 (or the second track section 46) and the linking rod 48 in the assembled sliding track assembly 40. In some embodiments, the first track section 44 has a first channel 444 recessed inward on a first end surface 442 thereof adjacent to the second track section 46, and the second track section 46 has a second channel 464 recessed inward on a second end surface 462 thereof adjacent to the first track section 44. By respectively inserting two ends of the linking rod 48 into the first channel 444 and the second channel 464, the first track section 44 and the second track section 46 can be aligned with and connected to each other. To eliminate the possibility that the first track section 44 and the second track section 46 may be disengaged from the linking rod 48, an outer surface of the linking rod 48 could have vertical patterns or protruding dots (not shown) provided thereon, whereby to increase the friction between the linking rod 48 and the walls of the first and second channels 444, 464. In other feasible embodiments, though not shown in the drawings, a diameter of the linking rod 48 could be slightly greater than inner diameters of the first and second channels 444, 464. Through tight engagement, the friction between the linking rod 48 and the first, second channels 444, 464 could be increased as well.

It has to be clarified that, since the sliding track assembly 40 drives the movable seat assembly 8 in a rotating manner, which leads to the tilting of the covering material 4, the transmission of torsion between the first track section 44, the second track section 46, and the linking rod 48 of the sliding track assembly 40 is critical. To make the sliding track assembly 40 have a smooth and steady torsion transmission, cross-sections of the first channel 444 and the second channel 464 of the first track section 44 and the second track section 46 correspond to the cross-section of the linking rod 48, and they are all non-circular. In some embodiments, cross-sections of the first channel 444 and the second channel 464 are hexagonal, and so is a cross-section of the linking rod 48 (as shown in FIG. 6 and FIG. 7). However, in other feasible embodiments, different shapes for the cross-sections such as semicircle, triangle, rectangle, or pentagon could be also selected based on the processing conditions and the consideration of cost.

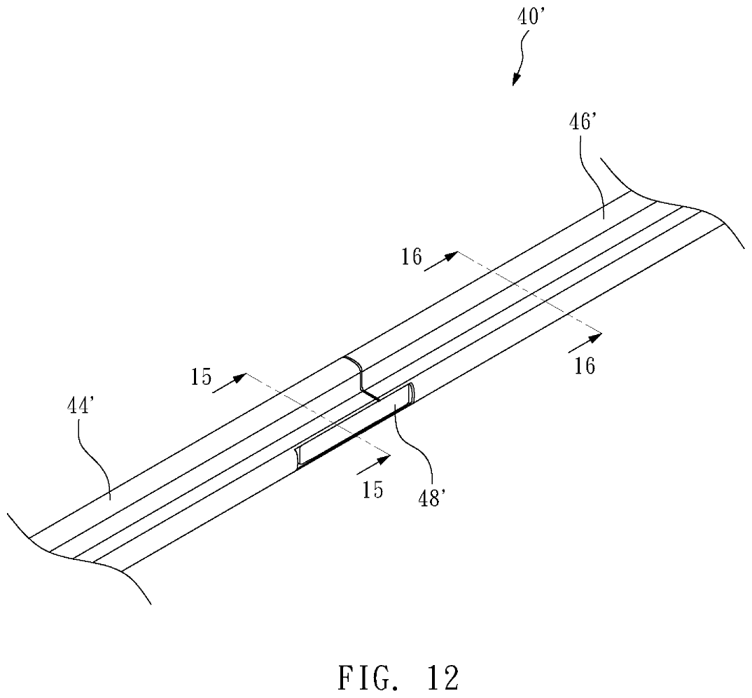

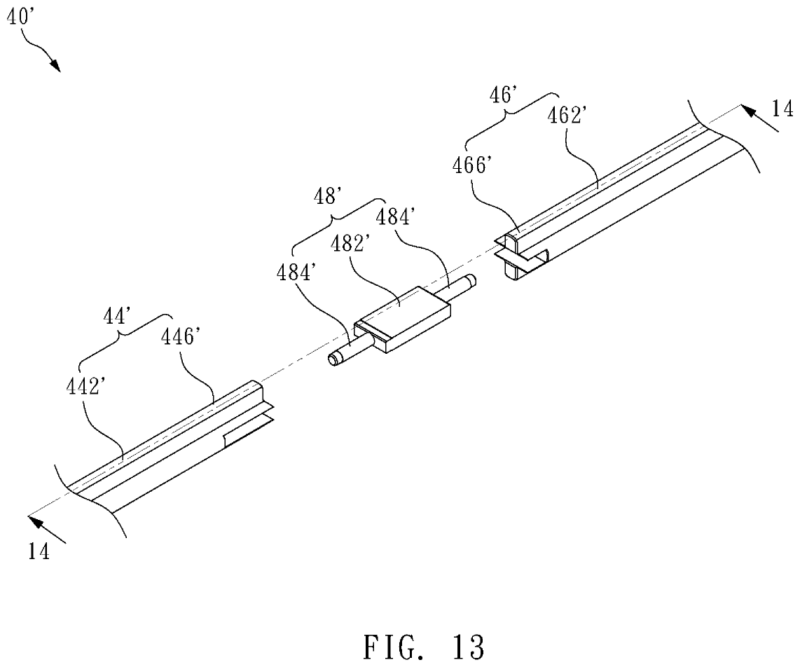

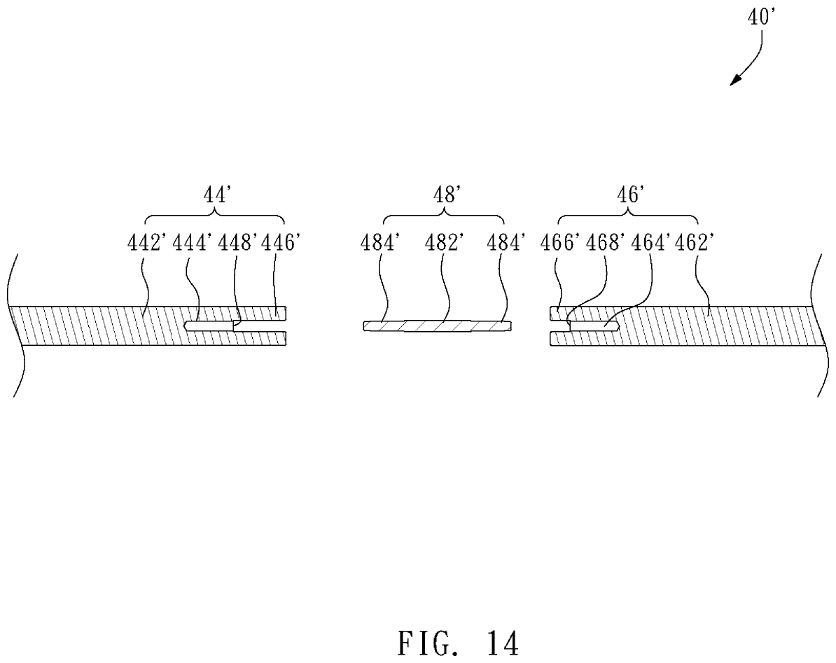

In other embodiments, the sliding track assembly can also have different arrangements other than that described above. As shown in FIG. 12 to FIG. 16, a first track section 44′ of a sliding track assembly 40′ has a first main body 442′, a third channel 444′, and a first extension section 446′, wherein the third channel 444′ is recessed into a third end surface 448′ in a direction toward the first main body 442′, and the first extension section 446′ extends from the third end surface 448′ in a direction away from the first main body 442′. Similarly and correspondingly, a second track section 46′ of the sliding track assembly 40′ has a second main body 462′, a fourth channel 464′, and a second extension section 466′, wherein the fourth channel 464′ is recessed into a fourth end surface 468′ in a direction toward the second main body 462′, and the second extension section 466′ extends from the fourth end surface 468′ in a direction away from the second main body 462′. A linking rod 48′ of the sliding track assembly 40′ includes an insertion section 482′ and two rod portions 484′, wherein the rod portions 484′ respectively extend outward from two ends of the insertion section 482′, and respectively correspond to the third channel 444′ of the first track section 44′ and the fourth channel 464′ of the second track section 46′. Furthermore, a shape of a cross-section of the insertion section 482′ corresponds to shapes of cross-sections of the first extension section 446′ and the second extension section 466′. When the first track section 44′, the second track section 46′, and the linking rod 48′ are assembled, two rod portions 484′ of the linking rod 48′ are respectively inserted into the third channel 444′ of the first track section 44′ and the fourth channel 464′ of the second track section 46′. Once the insertion section 482′ of the linking rod 48′ is assembled with the first extension section 446′ and the second extension section 466′, a shape of a cross-section of a junction between the insertion section 482′ and the first extension section 446′ and/or the second extension section 466′ is roughly the same as a shape of a cross-section of the first main body 442′ of the first track section 44′ and a shape of a cross-section of the second main body 462′ of the second track section 46′.

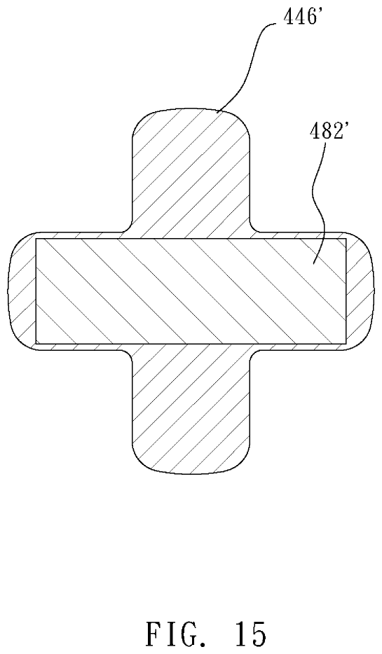

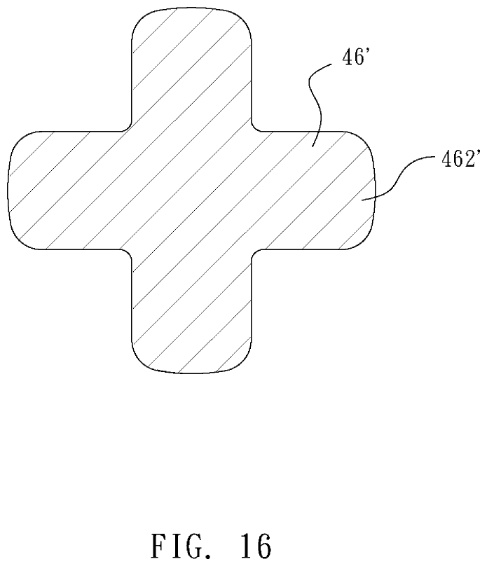

Specifically, as shown in FIG. 12 to FIG. 16, in some embodiments, the sliding track assembly 40′ is implemented as a shaft formed by four ribs, which means, shapes of cross-sections of the first main body 442′ of the first track section 44′ and the second main body 462′ of the second track section 46′ are cruciforms having a horizontal part and a vertical part, as shown in FIG. 16. With such design, the shape of said cross-section of the insertion section 482′ could fit into the horizontal part of the cruciform, as shown in FIG. 15, or could fit into the vertical part (not shown in the drawings); on the other hand, the shapes of said cross-sections of the first extension section 446′ and the second extension section 466′ could be other parts of the cruciform except the part for the insertion section 482′ (as shown in FIG. 15). Understandably, the above-mentioned arrangement is not the only option, and can be adjusted based on the processing conditions and costs. Similarly, the sliding track assembly 40′ can be also implemented in forms other than a shaft consisted of four ribs as mentioned above; however, the means of connecting the linking rod 48′ and the first, second track sections 44′, 46′ would still follow the above-mentioned technical means. In the current embodiment, once the linking rod 48′ is assembled with the first, second track sections 44′, 46′, the part belongs to the insertion section 482′ and the parts belong to the first and/or second extension sections 446′, 466′ are, when viewed from the cross-section of the junction therebetween, arranged in an interlocking manner that one surrounds the other, as shown in FIG. 15.

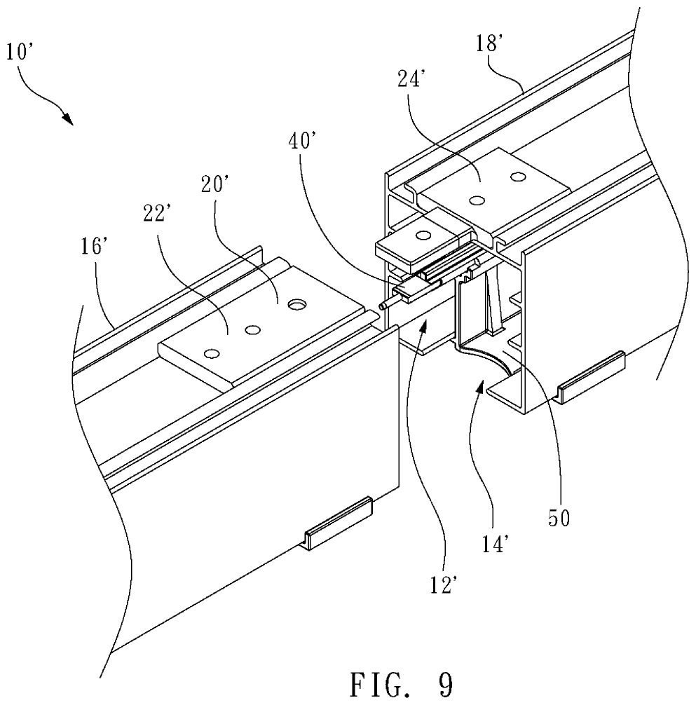

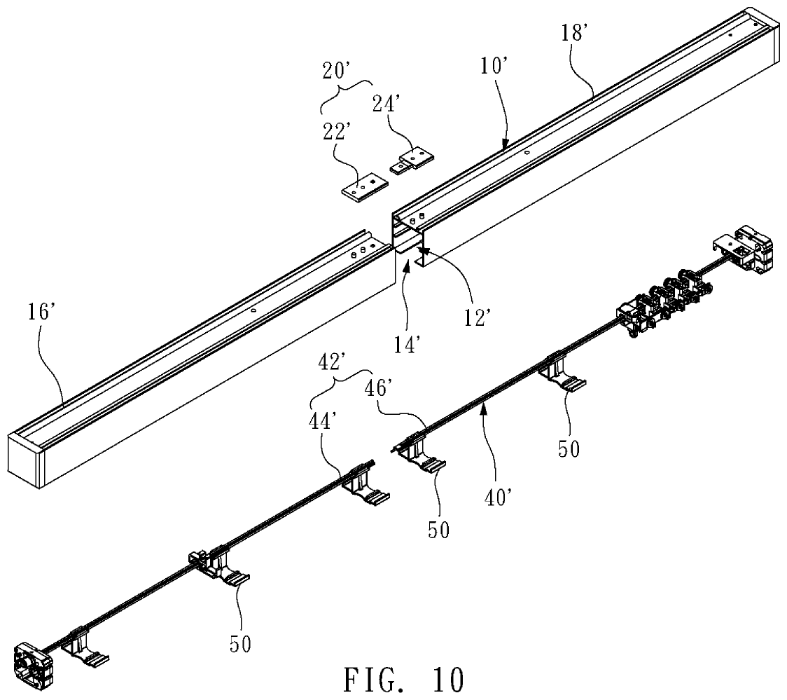

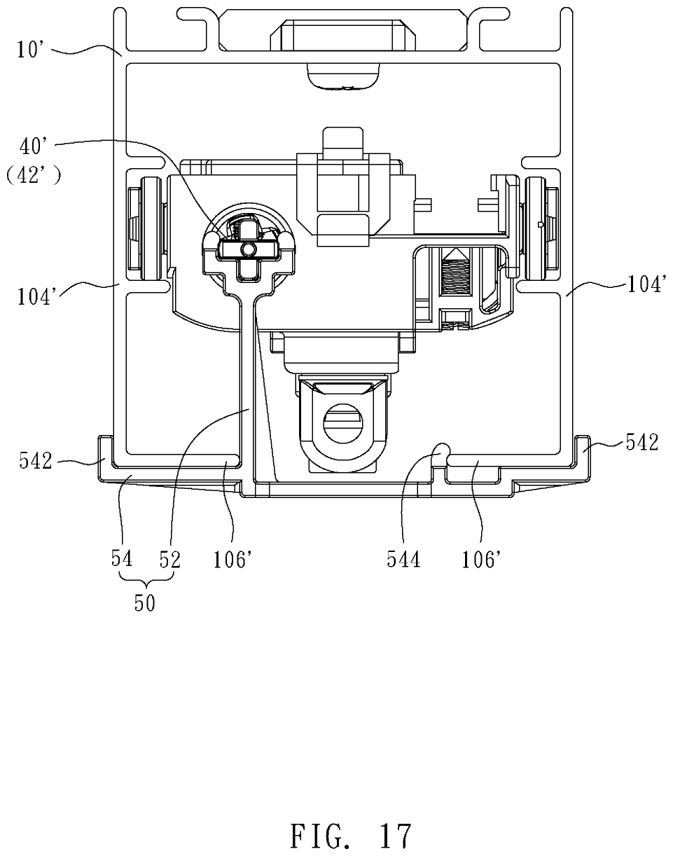

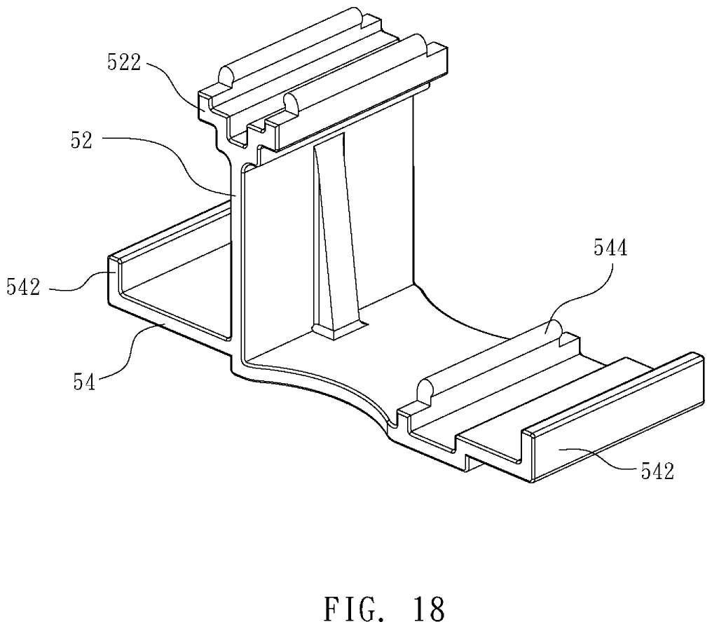

As shown in FIG. 8 to FIG. 10, when it is about to assemble the components, the assembling of the first sub-frame 16′ and the second sub-frame 18′ would be relatively easy, since the structures of the first sub-frame 16′, the second sub-frame 18′, and the fixing member 20′ of the frame 10′ are exposed. However, because the sliding track assembly 40′ is disposed in the receiving space 12′ of the frame 10′, a user can only stick fingers into the opening 14′ of the frame 10′ to correspondingly assemble the sliding track assembly 40′. For this reason, the assembling of the sliding track assembly 40′ is more difficult. To reduce the difficulty of assembling the sliding track assembly 40′, in some embodiments shown in FIG. 9, FIG. 10, FIG. 17, and FIG. 18, the headrail of the present invention further includes at least one track supporting member 50, which is detachably provided at the frame 10′. Said track supporting member 50 includes a supporting portion 52 and a holding portion 54, wherein a top of the supporting portion 52 supports the sliding track assembly 40′, and a bottom thereof is connected to the holding portion 54. Furthermore, the holding portion 54 is detachably snap-fitted to the bottom board 106′ and/or one of the side boards 104′, so that the track supporting member 50 can be fixed to the frame 10′. Preferably, there can be at least two track supporting members 50 respectively provided at the first sub-frame 16′ and the second sub-frame 18′, using their supporting portions 52 to restrict the rotation of the sliding track assembly 40′. With such design, during the process of connecting the first sub-frame 16′ and the second sub-frame 18′, the sliding track assembly 40′ could be stably assembled at a correct angle without the need of being held by hand.

An implementation of the track supporting member 50 is specifically described below. In an embodiment, the holding portion 54 has two upward extending blocking members 542 formed at two ends thereof, and an inner wall of each of the blocking members 542 respectively abuts against an outer wall of one of the side boards 104′. In addition, the holding portion 54 further has an upward extending snap-fitting member 544 formed at a middle section thereof, wherein the snap-fitting member 544 cooperates with the corresponding blocking member 542 to grip and hold the bottom board 106′, whereby the track supporting member 50 can be fixed on the frame 10′. Moreover, in some embodiments, the supporting portion 52 has a bearing recess 522 formed on a top thereof, wherein a shape of an inner outline of said bearing recess 522 corresponds to a shape of a bottom outline and/or a side outline of the sliding track 42′ of the sliding track assembly 40′, and therefore the supporting portion 52 could provide a sufficient supporting force to the sliding track 42′, ensuring the first and the second track sections 44′, 46′ to locate at the same height, and preventing the first and second track sections 44′, 46′ of the sliding track assembly 42′ from relative rotation. In this way, the first track section 44′ and the second track section 46′ could be confined at predetermined locations for assembly before they are assembled, which could reduce the condition that the first track section 44′ and the second track section 46′ are misaligned while being assembled.

In summary, the headrail and the opening covering provided in the present invention has at least the following advantages:

1. Through the cooperation between the frame and the fixing member, the first sub-frame and the second sub-frame of the frame can be either assembled or separated as required, which would increase the convenience of packaging and shipment, effectively reducing the overall volume and the shipping cost.

2. Through the cooperation between the sliding track and the linking rod, the first track section and the second track section of the sliding track assembly can be either assembled or disassembled as required; in addition, once the sliding track and the linking rod are assembled, the sliding track assembly could further provide the effect of effectively transferring torque of the adjusting rod to the movable seat assembly, whereby to drive the covering material to operate.

3. To assemble a disassembled headrail, the first track section and the second track section of the sliding track assembly could be confined in predetermined locations and angles in advance by the providing of the track supporting member, so that the difficulty of aligning the first track section and the second track section during the process of assembling could be eased, which would reduce the time required for the assembling procedure.

4. The present invention uses fixing members and linking rods to connect sub-frames and track sections, and therefore the disclosed sub-frames and track sections could be compatible with the sub-frames and track sections of a narrower opening covering. In other words, the sub-frames and track sections applied in the present invention could be used in opening coverings of different widths, and therefore the types of inventory and inventory costs could be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A headrail of an opening covering for a building opening, comprising:
a frame, which is defined to have a longitudinal axis, wherein a first sub-frame and a second sub-frame are formed in a direction along the longitudinal axis; and
a fixing member optionally provided at the frame, wherein, when the fixing member is provided at the frame, and bridges the first sub-frame and the second sub-frame at the same time, the first sub-frame and the second sub-frame are aligned with and connected to each other.

2. The headrail of claim 1, wherein the fixing member comprises a first fixing portion and a second fixing portion; when the fixing member bridges the first sub-frame and the second sub-frame to make the first sub-frame and the second sub-frame connected to each other in an aligned manner, the first fixing portion is fixedly provided at the first sub-frame, and the second fixing portion is fixedly provided at the second sub-frame.

3. The headrail of claim 2, wherein the first sub-frame comprises a first top board, and the second sub-frame comprises a second top board; the first fixing portion is provided at the first top board, and the second fixing portion is provided at the second top board.

4. The headrail of claim 2, further comprising a connecting member, which is optionally provided at an inner wall of the frame to bridge the first sub-frame and the second sub-frame.

5. The headrail of claim 1, wherein the frame has a hook portion formed on a top surface thereof, and the fixing member has a restriction portion on a bottom surface thereof; when the fixing member bridges the first sub-frame and the second sub-frame to make the first sub-frame and the second sub-frame aligned with and connected to each other, the restriction portion fits into the hook portion.

6. The headrail of claim 2, wherein the first fixing portion has a recess, and the second fixing portion has a projecting block; the projecting block is adapted to be correspondingly fitted into the recess.

7. The headrail of claim 6, wherein the projecting block is adapted to be correspondingly fitted into the recess in a detachable manner.

8. The headrail of claim 1, further comprising a sliding track assembly provided inside the frame, wherein the sliding track assembly comprises a sliding track and a linking rod; the sliding track comprises a first track section and a second track section, wherein the first track section and the second track section are adjacently provided in the direction along the longitudinal axis; the linking rod is provided at the sliding track and connecting the first track section and the second track section, so that the first track section and the second track section are aligned with and fixed to each other.

9. The headrail of claim 8, wherein the first track section has a channel formed on an end surface thereof facing the second track section, and the second track section also has a channel formed on an end surface thereof facing the first track section; the linking rod is adapted to be inserted into the channels.

10. The headrail of claim 9, wherein shapes of cross-sections of the channels of the first track section and the second track section correspond to a shape of a cross-section of the linking rod, and the shapes of the cross-sections of the channels and the shape of the cross-section of the linking rod are all non-circular.

11. The headrail of claim 8, wherein each of the first track section and the second track section has a main body, and further has a channel and an extension section formed at where the first track section and the second track section are adjacent to each other; the linking rod comprises an insertion section and two rod portions, wherein the rod portions respectively extend from two ends of the insertion section, and are respectively provided in a manner corresponding to the channel of the first track section and the channel of the second track section; a shape of a cross-section of the insertion section corresponds to a shape of a cross-section of each of the extension sections; when the first track section, the second track section, and the linking rod are assembled, each of the rod portions of the linking rod is respectively inserted into one of the channels, and a shape of a cross-section of a junction between the insertion section and each of the extension sections is substantially the same with a shape of a cross-section of the main body of the first track section or the main body of the second track section.

12. The headrail of claim 8, further comprising a track supporting member, which is detachably provided at the frame, wherein the track supporting member comprises a supporting portion; when the track supporting member is attached to the frame, an end of the supporting portion supports the sliding track assembly.

13. The headrail of claim 12, wherein the track supporting member comprises a holding portion; the supporting portion is connected to the holding portion, and the track supporting member is detachably provided at the frame through the holding portion.

14. The headrail of claim 13, wherein the frame defines a receiving space and an opening communicating with the receiving space; the frame comprises a bottom board, and the bottom board is provided with the opening; the holding portion of the track supporting member is adapted to be snap-fitted to the bottom board.

15. An opening covering for a building opening, the opening covering comprising:
a headrail comprising:
a frame, which is defined to have a longitudinal axis, wherein a first sub-frame and a second sub-frame are formed in a direction along the longitudinal axis; and
a fixing member optionally provided at the frame, wherein, when the fixing member is provided at the frame, and bridges the first sub-frame and the second sub-frame at the same time, the first sub-frame and the second sub-frame are aligned with and connected to each other.
